(19) United States
(12) Patent Application Publication
(10) Pub. No.: US 2026/0349753 A1
(43) Pub. Date: Nov. 5, 2026

(54) ADAPTIVE ARTIFICIAL INTELLIGENCE ASSISTANT USER INTERFACE

(71) Applicant: Microsoft Technology Licensing, LLC, Redmond, WA (US)

(72) Inventor: Sarah Ragab Ismail SALEH, Vancouver (CA)

(21) Appl. No.: 19/186,482

(22) Filed: Apr. 22, 2025

(51) Int. Cl. G06F 9/451; G06F 11/34

(52) U.S. Cl. CPC G06F 9/451; G06F 11/3438

(57) ABSTRACT

Methods, computer systems, and computer storage media are provided for providing adaptive AI assistant UIs. In embodiments, input data, such as context data and content data, associated with an application being executed at a user device is obtained. Thereafter, an interface mode indicating a manner in which to present an AI assistant UI within the application is determined based on the input data. Further, a placement for presenting the AI assistant UI within the application is determined based on the input data. The AI assistant UI may then be presented within the application at the user device, in accordance with the interface mode and the placement for presenting the AI assistant UI.

### BACKGROUND

Artificial intelligence (AI) assistants are commonly used tools utilized to enhance productivity. AI assistant user interfaces (UIs) are often placed in static locations. Such static locations may not be suitable for different workflows and application layouts, thereby limiting their ease of use. Further, in some instances, multiple disjointed AI assistant UIs are presented. For example, one AI assistant UI (e.g., an application chat) may be presented in one panel, while another AI assistant UI (e.g., design interface) may be overlayed over content. Such multiple disjointed AI assistant UIs may result in a cluttered user interface and a disjointed user experience.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for efficiently and effectively providing an AI assistant UI in an adaptive manner. In this way, a user may be presented with a single AI assistant UI in a manner that is effective and efficient for tasks relevant to the user. In particular, as input data, such as user input data, context input data, and/or content input data, is obtained, a manner in which to present an AI assistant UI may be adapted or morphed in accordance with the context and content such that the AI assistant UI is presented in a manner appropriately suited for the user. In this regard, the AI assistant UI is dynamically morphed into an interface that adapts to user needs, context, and/or content.

### BRIEF DESCRIPTION OF DRAWINGS

The technology described herein is described in detail below with reference to the attached drawing figures, wherein:

FIG. 1 is a block diagram of an exemplary system for providing an adaptive AI assistant UI, suitable for use in implementing aspects of the technology described herein;

FIG. 2 is an example implementation for providing an adaptive AI assistant UI via an AI assistant manager, in accordance with aspects of the technology described herein;

FIG. 3 provides an example implementation of flow for providing an adaptive AI assistant UI, in accordance with aspects of the technology described herein;

FIGS. 4A-4L provide example user interfaces of an adaptive AI assistant UI, in accordance with aspects of the technology described herein;

FIG. 5 provides an example method flow for providing an AI assistant UI in an adaptive manner, in accordance with aspects of the technology described herein;

FIG. 6 provides another example method flow for providing an AI assistant UI in an adaptive manner, in accordance with aspects of the technology described herein;

FIG. 7 provides another example method flow for providing an AI assistant UI in an adaptive manner, in accordance with embodiments described herein;

FIG. 8 is a block diagram of an exemplary computing environment suitable for use in implementing aspects of the technology described herein; and

FIG. 9 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Intelligent assistants, also referred to as AI assistants, generally use AI to perform tasks, provide services, and assist users in various ways. An intelligent assistant or AI assistant generally refers to any use of AI technology that may perform tasks or services based on input. In embodiments, the technology may perform tasks facilitated through AI technology, such as natural language processing, machine learning, or other AI technologies. For example, an AI assistant may perform task automation, information retrieval, and/or the like.

AI assistant UIs are generally presented via a display to facilitate user interaction with AI, for example, by providing a structured and intuitive way to communicate, receive responses, and take actions. Oftentimes, AI assistant UIs are placed in a static location, such as a dedicated pane. Such static locations, however, may not be suitable for different workflows and application layouts. As such, the ease of use of such AI assistant UIs may be limited and ineffective. Further, in many cases, multiple disjointed AI assistant UIs are presented. For example, different portions of an application may require distinct AI interactions for specific tasks. For instance, an AI-powered writing assistant may provide grammar suggestions in a sidebar, while a separate AI chat UI provides content brainstorming support in a floating window. A s another example, one AI panel may be dedicated to generating formulas, while another creates data visualizations. Such multiple disjointed AI assistant UIs, however, may result in cluttered UI and disjointed user experience.

In addition to the inefficient and ineffective presentation of AI assistant UI, computing resources may be unnecessarily consumed in order for a user to more effectively identify relevant information. As one example, unoptimized content loading and processing may occur. For instance, in cases in which the UI loads are large or excessive, memory and processing power may be unnecessarily utilized. Further, AI-driven assistants may retrieve irrelevant data, for example, in cases in which the assistants are running in the background. As another example, inefficient memory allocation may occur. For instance, unnecessary UI elements may unnecessarily use RAM, leading to increased memory pressure. Further, complex UIs with numerous panels, pop-ups, or overlays may increase GPU texture load. As another example, unnecessary background processes and event listeners may consume unnecessary processing power. Such unnecessary background processes and event listeners may increase as the number AI assistant UIs are presented on a display screen. Similarly, UIs fetching unnecessary data (e.g., auto-loading content a user does not interact with) may unnecessarily use bandwidth and storage. Such bandwidth and storage usage may be exacerbated when multiple AI assistant UIs are presented. In this regard, an inefficient presentation of AI assistant UIs can unnecessarily result in decreased throughput and increased network latency, thereby increasing usage of computing and network resources.

Embodiments described herein efficiently and effectively provide an AI assistant UI in an adaptive manner. In this way, a user may be presented with a single AI assistant UI in a manner that is effective and efficient for tasks relevant to the user. In particular, as input data, such as user input data, context input data, and/or content input data, is obtained, a manner in which to present an AI assistant UI may be adapted or morphed in accordance with the context and content such that the AI assistant UI is presented in a suitable manner. In this regard, the AI assistant UI is dynamically morphed into an interface that adapts to user needs, context, and/or content.

At a high level, a single AI assistant UI may be transformed into various UI forms to transition to a proactive tool that follows the user through interactions with a document or canvas. The adaptiveness enables an AI assistant manager to be presented in a way that adjusts to the user's workflow, thereby providing proximity-based interactions, minimized distractions, enhanced usability, and context-aware assistance (e.g., summarizing, suggesting edits, providing insights, etc.), as deemed suitable to the workflow.

In operation, various types of input data may be collected or obtained. For example, user queries may be obtained as well as user activity, an indication of an application, an indication of a document mode, content, etc. The input data can be used to determine a particular interface mode for presenting an AI assistant UI. Examples of interface modes include a contextual mode, a dialog mode, a chat mode, and a voice mode. As one example, one interface mode may be selected in cases in which a blank or empty canvas or document exists, while another interface mode may be selected in cases in which a canvas or document includes content. In some cases, an interface mode may be selected using a rules-based approach. In addition to identifying an interface mode for presenting an AI assistant UI, an AI agent may be selected or identified. Examples of AI agents include a design AI agent, a document AI agent, an app chat AI agent, a presentation AI agent, a data analysis AI agent, etc. An AI agent may facilitate identification of a manner in which to present an adaptive AI assistant UI. A s such, upon selecting an AI agent, a prompt may be generated to provide to the AI agent to obtain UI data indicating a manner in which to present an adaptive AI assistant UI. In some cases, the prompt may include an indication of the identified interface mode and input data for use in generating UI data. UI data generated by the AI agent may include, for example, a location at which to place the adaptive AI assistant UI, content to include in association with the adaptive AI assistant UI (e.g., task recommendations, responses to queries, etc.), a size for the adaptive AI assistant UI, etc. In accordance with obtaining UI data, the UI data may be used to present the AI assistant UI in a manner that is adaptive to the context or user desires indicated in the input data.

Advantageously, the adaptive AI assistant UI enables minimization of context switching by aligning with user actions, thereby enabling more efficient task execution and, as such, reduce unnecessary use of computing resources. In addition, the proactive and adaptive assistance enables dynamic tailoring of behavior and appearance, thereby reducing cognitive load while enhancing discoverability of advanced or core features, such as summarization and real-time insights. Further, the adaptive design scales seamlessly across applications, thereby creating a unified and predictable user experience, regardless of the task or platform. As described herein, the adaptive AI assistant UI may also ensure minimal screen clutter by dynamically resizing and repositioning itself to avoid interfering with the user's focus. As such, the adaptive AI assistant UI enhances user productivity and satisfaction. In addition to enhancing user productivity and satisfaction, the effectiveness and efficiency of the adaptive AI assistant UI enables a more efficient use of computing resources, for example, as compared to conventional implementations in which multiple AI assistant UIs may be concurrently presented.

### Overview of Exemplary Environments for Facilitating Adaptive AI Assistant UIs

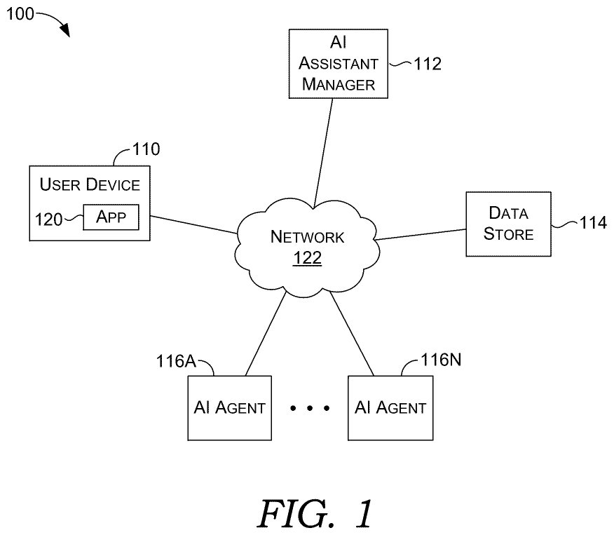

Referring initially to FIG. 1, a block diagram of an exemplary network environment 100 suitable for use in implementing embodiments described herein is shown. Generally, the system 100 illustrates an environment suitable for facilitating adaptive AI assistant UIs. Among other things, embodiments described herein efficiently and effectively provide an adaptive AI assistant UI in a suitable manner. In this way, an adaptive AI assistant UI is presented in a manner that improves workflow integration, proactive and adaptive assistance, consistency across applications, and/or display optimization. In particular, an AI assistant UI is provided in a manner that automatically adapts or morphs to a form that is suitable to provide timely, relevant, and non-intrusive assistance. Further, user UI manipulations may be obtained in association with a presented AI assistant UI to further enable an adaptive and suitable AI assistant UI. For example, a user may provide feedback or manipulations indicating preferences related to the presentation of an AI assistant UI. In this way, the user interactions may modify presentation of the AI assistant UI, such as the placement or size of the AI assistant UI. Providing an adaptive AI assistant UI facilitates an environment that enhances user productivity and satisfaction.

The network environment 100 includes a user device 110, an AI assistant manager 112, a data store 114, and AI agents 116a-116n (referred to generally as AI agent[s] 116). The user device 110, the AI assistant manager 112, the data store 114, and the AI agents 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the AI assistant manager 112, and/or the AI agents 116. For example, the data store 114 may store rules, input data, and/or the like.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, in some cases, the user device 110 and/or AI agents 116a-116n may be in communication with the AI assistant manager 112 via a mobile network or the Internet. Additionally or alternatively, the AI assistant manager 112 may be in communication with data store 114 and/or AI agents 116a-116n via a local area network. Further, although the environment 100 is illustrated with a network, one or more of the components may directly communicate with one another, for example, via HDMI (High-Definition Multimedia Interface) and DVI (Digital Visual Interface). Alternatively, one or more components may be integrated with one another, for example, at least a portion of the AI assistant manager 112 and/or data store 114 may be integrated with the user device 110. For instance, a portion of the AI assistant manager 112 may be integrated with the user device (e.g., via application 120). As another example, at least a portion of the AI agents 116 may be integrated with the AI assistant manager 112 and/or the user device 110.

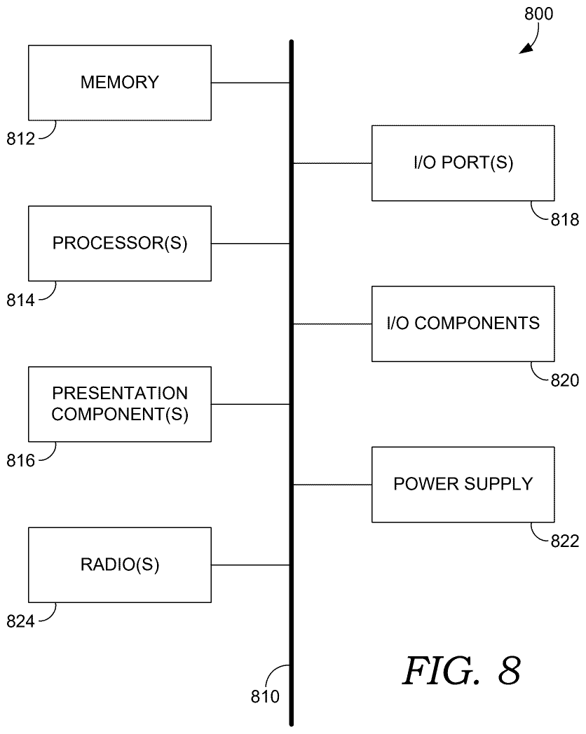

The user device 110 can be any kind of computing device capable of facilitating the generation and/or presentation of an AI assistant UI in an adaptive manner. For example, in an embodiment, the user device 110 can be a computing device such as computing device 800, as described above with reference to FIG. 8. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating the generation and/or presentation of an AI assistant UI in an adaptive manner. AI assistant capabilities may be integrated into a variety of applications across various domains, for example, to enhance user productivity, facilitate decision-making, and automate repetitive tasks. Examples of applications may include code editors and integrated development environments, productivity tools and office suites, customer relationship management (CRM) systems, project management software, collaboration platforms, content creation tools, e-commerce platforms, data analysis and business intelligence tools, healthcare applications, or the like. Any of such applications may include an AI assistant tool or technology that may facilitate generating and/or providing an adaptive AI assistant UI. As such, application 120 may be any type of application that may facilitate generation and/or presentation of an adaptive AI assistant UI. One example of an AI assistant functionality or tool that may be included in an application is Microsoft Copilot. In some implementations, the application(s) comprises a web application, which can run in a web browser, and may be hosted at least partially server-side (e.g., via AI assistant manager 112). In addition, or instead, the application(s) can comprise a dedicated application. In some cases, the application is integrated into the operating system (e.g., as a service).

User device 110 can be a client device on a client-side of operating environment 100, while AI assistant manager 112 can be on a server-side of operating environment 100. AI assistant manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or AI assistant manager 112 remain as separate entities.

In an embodiment, the user device 110 is separate and distinct from the AI assistant manager 112, the data store 114, and the AI agents 116 illustrated in FIG. 1. In another embodiment, the user device 110 is integrated with one or more illustrated components. For instance, the user device 110 may incorporate functionality described in relation to the AI assistant manager 112. For clarity of explanation, embodiments are described herein in which the user device 110, the AI assistant manager 112, the data store 114, and the AI agents 116 are separate, while understanding that this may not be the case in various configurations contemplated.

As described, a user device, such as user device 110, can facilitate generating and/or presenting an adaptive AI assistant UI in an effective and efficient manner. An adaptive AI assistant UI generally refers to an AI assistant UI that is adaptive to context, content, and/or user preferences. In this way, an AI assistant UI is presented in a manner to facilitate efficiency and productivity, while minimizing distraction. For example, embodiments described herein enable the AI assistant manager 112 to identify a manner in which to present an AI assistant UI via a display screen, which may then be provided to the user for viewing via application 120 of the user device 110.

A user device 110, as described herein, is generally operated by an individual or entity interested in viewing information. In some cases, identification and/or presentation of an adaptive AI assistant UI may be initiated at the user device 110. For instance, in some cases, a user may navigate to a desired application and open the application to initiate a new document or view or edit an existing document. Further, in some cases, a user may navigate to an AI assistant UI (e.g., a chat box) and input or select a query. A s one example, the user input query may include or be a natural language input by a user. A user input query may include a request in the form of a question, command, or description of a task. Based on the input or initiation of the query, identification and/or presentation of an AI assistant UI may be adapted to the context and/or content. For example, a user may navigate to an application, via the Internet, and input a text query to obtain an AI response and, based on context data, an AI assistant UI may be modified in an effective manner.

As described, the user device 110 can include any type of application, which may be a stand-alone application, a mobile application, a web application, or the like. In some cases, the functionality described herein may be integrated directly with an application or may be an add-on, or plug-in, to an application.

The user device 110 may communicate with the AI assistant manager 112 to initiate identification and/or presentation of an adaptive AI assistant UI. In embodiments, for example, a user may utilize the user device 110 to initiate generation and/or presentation of an AI assistant UI in an adaptive manner via the network 122. For instance, in some embodiments, the network 122 may be the Internet, and the user device 110 interacts with the AI assistant manager 112 to initiate identification and/or presentation of a manner in which to present an adaptive AI assistant UI. In other embodiments, for example, the network 122 may be an enterprise network associated with an organization. In yet other embodiments, the AI assistant manager 112 may additionally or alternatively operate locally on the user device 110 to provide local responses. It should be apparent to those having skill in the relevant arts that any number of other implementation scenarios may be possible as well.

In accordance with the AI assistant manager 112 determining a manner in which to present an adaptive AI assistant UI (e.g., based on context or user interactions), such instructions may be returned to the user device 110 for use in presenting the adaptive AI assistant UI accordingly. In this way, the application 120 may facilitate presentation of an adaptive AI assistant UI in a manner that is suitable for efficiently and effectively utilizing the application 120. A s described herein, the presentation of such an adaptive AI assistant UI may be in various formats, locations, sizes, etc., based on suitability to enhance performance and user experience.

With continued reference to FIG. 1, the AI assistant manager 112 can be implemented as server systems, program module(s), virtual machine(s), component(s) of a server or servers, networks, and the like. At a high level, the AI assistant manager 112 manages presentation of AI assistant UIs in an adaptive manner. A n AI assistant manager generally refers to a service or engine that performs AI assistant UI-related services. In particular, the AI assistant manager obtains various input data, such as user input data, context input data and/or content input data, and, in response, provides an indication of a manner in which to present an AI assistant UI. In this regard, in association with obtaining input data, the AI assistant manager 112 can identify a manner in which to present or display an adaptive AI assistant UI. Such an AI assistant manager 112 may communicate with application 120 operating on user device 110 to provide back-end services to application 120. Alternatively or additionally, the AI assistant manager 112 can operate at the user device to provide local results.

In determining a manner in which to present an adaptive AI assistant UI, the AI assistant manager 112 may identify an interface mode and/or an AI agent for use in presenting the adaptive AI assistant UI. In embodiments, input data, such as user input data, context input data, and/or content input data, is used to identify an interface mode and/or an AI agent for use in presenting an adaptive AI assistant UI. The identified AI agent may be used to generate UI data that corresponds with the identified interface mode for use in presenting an AI assistant UI in a user-preferred and/or contextually adaptive manner. As such, to obtain UI data, one or more AI agents 116 may be used to generate UI data in accordance with input data. Such UI data, which generally indicates a manner in which to present data, is provided to the user device to facilitate display of an adaptive AI assistant UI. The AI assistant UI may be presented to a user via a display screen in any number of ways that is adaptive to a user and/or application context and content.

Further, as described herein, the AI assistant manager 112 enables user manipulation in relation to a displayed AI assistant UI. In this way, user feedback may be obtained in association with a displayed AI assistant UI to facilitate modification of a placement, size, and/or content of the AI assistant UI. For example, in some embodiments, a user may dock and/or undock an AI assistant UI. As another example, in some embodiments, a user may move an AI assistant UI within the display screen. As another example, a user may select to morph an initially displayed AI assistant UI to an app chat AI assistant UI. In this way, the user may manipulate an AI assistant UI to be presented in a manner that is suitable to the user. Obtaining and using such user feedback in association with an AI assistant UI facilitates a more desired or tailored generation and/or presentation of data for the user, thereby providing a better and more efficient user experience.

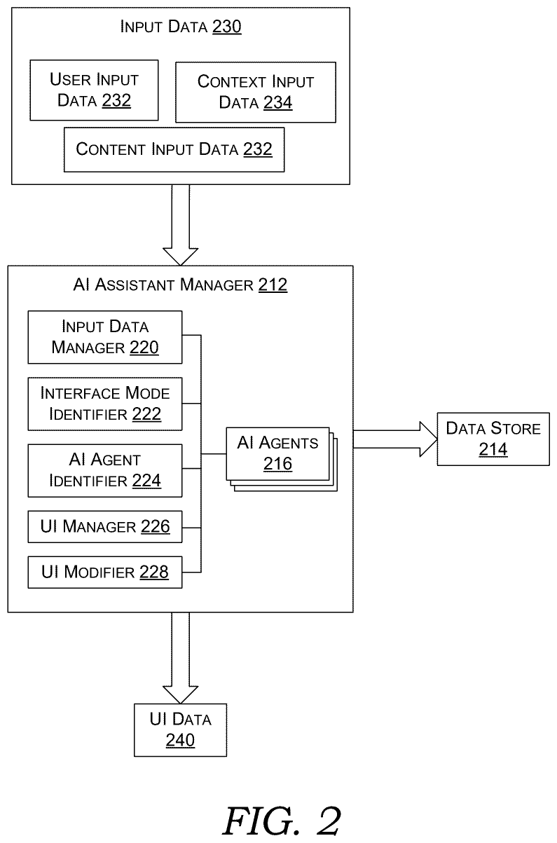

Turning now to FIG. 2, FIG. 2 illustrates an example implementation for an adaptive AI assistant UI via AI assistant manager 212. The AI assistant manager 212 is communicatively coupled with the data store 214. The data store 214 is configured to store various types of information accessible by the AI assistant manager 212 or other server. In embodiments, AI agents (such as AI agents 216), user devices (such as user devices 110 of FIG. 1), and/or AI assistant manager (such as AI assistant manager 212) can provide data to the data store 214 for storage, which may be retrieved or referenced by any such component. As such, the data store 214 may store input data, UI data, and/or the like.

In operation, the AI assistant manager 212 is generally configured to manage an adaptive AI assistant UI in an efficient and effective manner. In embodiments, the AI assistant manager 212 includes a set of one or more AI agents 216, an input data manager 220, an interface mode identifier 222, an AI agent identifier 224, a UI manager 226, and a UI modifier 228. According to embodiments described herein, the AI assistant manager 212 can include any number of other components not illustrated. In some embodiments, one or more of the illustrated components 216, 220, 222, 224, 226, and 228 can be integrated into a single component or can be divided into a number of different components. Components 216, 220, 222, 224, 226, and 228 can be implemented on any number of machines and can be integrated, as desired, with any number of other functionalities or services.

Initially, AI agents 216 may include any type of technology that may be used by any component(s) of the AI assistant manager 212 to facilitate presentation of AI assistant UIs in an adaptive manner. Various types of technology may include natural language processing technology, large language models, small language models, rules, algorithms, artificial intelligence, machine learning, or other computing technologies. Some of such technologies are described herein in association with the various components, but embodiments are not intended to be limited herein. Further, although illustrated in connection with the AI assistant manager 212, such technology may be separate from, but in communication with, the AI assistant manager 212. For example, the AI assistant manager 212 may route requests to separate, independent AI agents that exist on different servers.

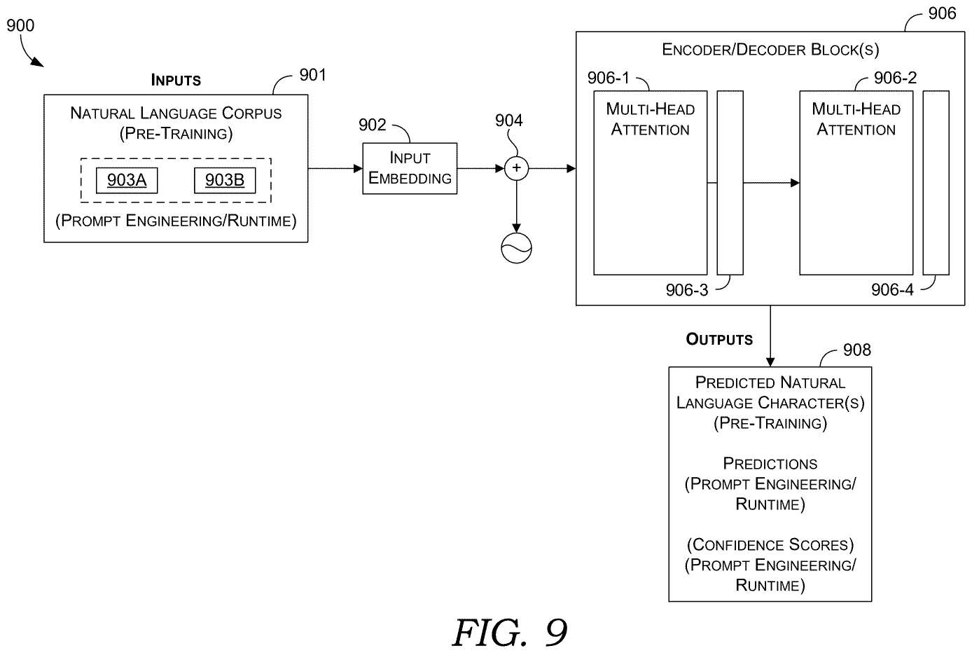

In embodiments, an AI agent 216 may be, include, or access any number of machine learning models or technologies. In some embodiments, a machine learning model in the form of an LLM is used to generate an AI response. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that is trained on an extensive quantity of unlabeled text using self-supervising learning. Oftentimes, LLM s have a parameter count in the billions, or higher. Some examples of LLM s are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the AI agent(s) 216 takes on the form of or uses an LLM, but various other machine learning models can additionally or alternatively be used. One example of an LLM is provided below in reference to FIG. 9.

Turning to the input data manager 220, the input data manager 220 is generally configured to manage input data, such as input data 230. Input data generally refers to any data input or provided to the AI assistant manager 212 that may be used to facilitate display of an AI assistant UI. In particular, input data may be used to determine a manner in which to present an AI assistant UI via a user device. Input data 230 may include user input data 232, context input data 234, and/or content input data 236.

User input data, such as user input data 232, generally refers to input provided by a user at the user device, such as user device 102 of FIG. 2. User input data may refer to explicit information provided by a user to interact with an application, such as queries, commands, and/or selections. As one example, user input data may include an indication or selection to view or use an AI assistant tool. As another example, user input data may include a request or query to view data (e.g., what the user is asking for, such as “summarize this document”). User input data may be in various formats, such as textual input (e.g., typed queries), voice input (e.g., spoken commands), selection-based input (e.g., selecting an option, button, etc.), etc. In some cases, user input data may be provided in the form of, or included in, a prompt. For example, the user device, or portion thereof (e.g., application), may dynamically construct a prompt based on user input.

Context input data, such as context input data 234, may refer to any context data associated with the application being utilized. Context input data may include implicit, system-generated, and/or environmental data related to utilization of an application. In some cases, context input data may be collected passively based on the user's environment, behavior, and system state. As one example, context input data may include user activity and/or interaction history, such as recent actions taken in an application (e.g., editing a document, switching between pages or documents, etc.), prior interactions with an AI assistant user interface, frequently used commands or preferences, etc. As another example, context input data may include an indication of an application and/or platform currently in use or being interacted with by a user. As another example, context input data may include context associated with user selections. For example, assume a user selects a portion of data presented on a display screen (e.g., a column of data, an image on a presentation, a paragraph of text, etc.). In such cases, context input data may include headers, metadata, summaries, labels, formats, etc. associated with the selected data. As another example, context input data may include a document mode. A document mode refers to a mode or interaction state associated with a document of an application. Examples of document modes may include a preview mode document, an editing mode document, a source editing mode document, a collaborative mode document, and the like. A preview mode document refers to a document that is being viewed by not edited (e.g., read-only presentation, locked file). A n editing mode document refers to a document that is being modified (e.g., an open Word file, a Google Doc in editing mode). A source editing mode document refers to a document where the underlying structure or code is being modified (e.g., HTML source, Markdown file, or raw XML). A collaborative mode document refers to a document that multiple users can edit in real-time (e.g., Google Docs with shared access). In some cases, context input data may be provided in the form of, or included in, a prompt. For instance, as described, a prompt may be generated at the user device based on user input and/or local context. In this way, context may be incorporated into the prompt and obtained as input data via the prompt.

Content input data, such as content input data 236, may refer to any content data associated with the application being utilized. In some cases, content input data may include text and/or images associated with a page, document, or canvas being presented. In other cases, content input data may include text and/or images associated with a selected portion of a page, document, or canvas. For example, assume a user selects a portion of a presentation or spreadsheet. In such a case, content associated with the selected portion may be provided as content input data.

Input data may be obtained at the input data manager 220 at various times. In some cases, such data may be provided in real time as the data is provided or detected. A s another example, input data may be provided to the input data manager 220 in a periodic manner (e.g., upon the lapse of a time duration). In other cases, input data may be provided to the input data manager 220 in association with an occurrence of an input event. For example, based on a user selection to provide input data.

Although generally described as receiving input data from a user device, as can be appreciated, in some cases, the input data manager 220 may obtain, receive, or retrieve input data from another component. For example, in accordance with an occurrence of a time or an event, the input data manager 220 may retrieve input data (e.g., context input data, content input data, etc.) from a data store, such as data store 214.

The interface mode identifier 222 is generally configured to identify an interface mode for presenting an AI assistant UI in an adaptive manner. In embodiments, an interface mode is identified based on input data obtained at input data manager 220. An interface mode may refer to a mode indicating how a user may interact with an AI assistant and/or how information is presented. Examples of interface modes include a chat mode, a voice mode, a dialog mode, and a contextual mode. Chat mode generally refers to a text-based conversational UI. In a chat mode, a text-based format may be used where a user types queries, and the system responds in an iterative exchange. Voice mode generally refers to a mode in which users interact via speech. In some cases, responses are also provided in an audio format. Dialog mode generally refers to structured interactions in which the user is guided through a process (e.g., form-filling, troubleshooting, etc.). Such a mode may include step-by-step prompts and decision-making elements, thereby ensuring a user progresses logically through the interaction. Contextual mode generally refers to interactions dynamically adapted to on-screen context, such as inline suggestions, smart replies, enhanced document editing, etc. Such modes may indicate how the UI behaves, what elements are displayed, and how the user and/or system interact to provide an optimized experience for the corresponding interface mode.

In embodiments, the interface mode associated with an AI assistant UI may be determined by the interface mode identifier 222 based on the input data, such as user input data, context input data (e.g., user activity, application identifier, document mode, etc.), and/or content input data. As one example, in accordance with initially accessing a canvas, a chat mode may be initially selected for an AI assistant UI. As another example, in cases in which a document or visual design includes an extensive amount of content or elements, a voice mode may be selected for an AI assistant UI. In some cases, in addition to input data, an interface mode may be identified based on an identified AI agent, UI content to be presented (e.g., returned by an AI agent), and/or the like. In such cases, the interface mode identifier 222 may obtain data from such components of the AI assistant manager 212 to facilitate identification of an interface mode. As one example, based on an identification to use a particular AI agent, a particular interface mode (e.g., chat mode) may be identified or selected by the interface mode identifier 222.

Any type of technology may be used to identify an interface mode. In one example, rules-based logic may be used to an interface mode based on input data. For instance, assume input data indicates a user has initially opened an application. In such a case, the interface mode identifier 222 may apply rules-based logic and determine an interface mode in which to present an AI assistant UI. In another example, a machine learning model(s) may be used to predict an interface mode for an AI assistant UI based on past user interactions.

The AI agent identifier 224 is generally configured to identify an AI agent(s) to use in association with the application being utilized. Any number or type of AI agents may be available for selection by an AI agent identifier 224. In some embodiments, a single AI agent is selected from among a set of AI agents.

An AI agent generally refers to an intelligent component designed to perform a specific task(s). An AI agent may operate within a defined domain and leverage a machine learning model(s) to assist users in an application(s). In this regard, an AI agent may include, or access, an LLM. Examples of AI agents may include a designer AI agent, an app chat AI agent, a document AI agent, a presentation AI agent, a data analysis AI agent, and/or the like. A designer AI agent may refer to an AI agent that assists with visual design, layout, branding, and creative content generation. An app chat AI agent generally refers to an AI agent that enables conversational interactions, task automation, and/or contextual assistant. An app chat AI agent may enable a user to interact with an application via a chat-based interface, for example, guiding users through workflows, answering questions, and offering relevant suggestions. A document AI agent generally refers to an AI agent that assists with creating, analyzing, summarizing, editing, and management documents. A document AI agent may enhance productivity by automating tasks, such as text generation, formatting, data extraction, content structure, etc. A presentation AI agent generally refers to an AI agent that assists users in creating, enhancing, and delivering presentations. Such an agent may be used to automate design, generate content, suggest improvements, and optimize slide layouts for clarity and engagement. A data analysis AI agent, or a spreadsheet AI agent, generally refers to an AI agent that helps users with data entry, analysis, visualization, automation, and formula generation within a spreadsheet application.

In embodiments, the AI agent identifier 224 may identify or select an AI agent using the input data, such as user input data, context input data (e.g., user activity, application identifier, document mode, etc.), and/or content input data. As one example, in accordance with initially accessing an application, an AI agent corresponding with the application may be initially identified. In some cases, in addition to input data, an AI agent may be identified based on an identified interface mode and/or the like. In such cases, the AI agent identifier 224 may obtain data from such components of the AI assistant manager 212 to facilitate identification of an AI agent. A s one example, based on an identification of a particular interface mode (e.g., chat mode), a particular AI agent (e.g., app chat AI agent) may be identified or selected by the AI agent identifier 224.

A n AI agent may be identified in any of a number of ways. In one example, rules-based logic may be used to identify an AI agent, from among a set of AI agents, to use based on input data or other data. For instance, assume input data indicates a user is utilizing a presentation application. In such a case, the AI agent identifier 224 may apply rules-based logic and determine to use a presentation AI agent. In another example, a machine learning model(s) may be used to predict a best AI agent to utilize based on input data or other data.

The UI manager 226 is generally configured to manage AI assistant UIs in an adaptive manner. In this regard, the UI manager 226 may identify UI data for use in presenting an AI assistant UI. UI data generally refers to any data indicating how a UI should be rendered, presented, and/or interacted with on a user device, such as user device 110 of FIG. 1. In this regard, UI data may provide parameters for elements, such as content, layout, styling, etc. In embodiments, UI data may include any data indicating placement, presentation, and/or content associated with an AI assistant UI.

In embodiments, the UI manager 226 communicates with an identified AI agent(s) 216 to obtain or identify UI data. In this regard, an identified AI agent may be used to obtain data for presenting via an AI assistant UI. Accordingly, the UI manager 226 may facilitate generation of a prompt to provide as input to an AI agent to obtain a corresponding response. A prompt may be generated to include any amount or type of data. A prompt may include an indication of an interface mode in which a UI is desired to be presented. A prompt may also include any type of input data to provide context for generating a response. As described, input data may include user data, such as a query or request, input by a user. Additionally or alternatively, input data may include context input data that indicates user activity, an application being utilized or accessed, a document mode, context associated with a selected portion of content, and/or the like. Further, input data may include content input data that represents content in a document or canvas being presented in association with an application. For example, user selected content may be included in a prompt.

In some cases, the prompt may include a specific instruction. In this way, based on the input data, interface mode, AI agent, etc., the UI manager 226 may determine an instruction for requesting a response from an AI agent. For example, the UI manager 226 may determine a desired attribute for an AI assistant UI (e.g. a core AI feature to expose to a user) and request such an attribute. In other cases, a prompt may include a general instruction, such as a request to generate data formatted for UI presentation that aligns with the specified interface mode. In such a case, the AI agent 216 may determine a response in association with the data provided in the prompt.

The UI manager 226 may provided the prompt, as input, to the identified AI agent 216. The AI agent analyzes the data in the prompt and provides returns or responds with data for presenting via an AI assistant UI. In some cases, the AI agent determines a manner in which to present the AI assistant UI in accordance with the desired interface model and input data. In this way, the AI assistant UI is adapted to the context in which a user is utilizing an application.

A n AI agent 216 may generate and/or provide various types of content for an AI Assistant UI. In some cases, an AI agent may generate content that corresponds to a user request or query. For example, assume a user requests creation of a presentation on a specific topic. In such a case, a presentation AI agent may generate a series of slide layouts tailored to that subject. Such a response may include title slides, bullet points, and relevant design elements (e.g., suggested color schemes and fonts). A s another example, assume a user requests assistance with a report. In such a case, a document AI agent may provide an outline for the report's structure, including suggested headings, introductory paragraphs, and relevant formatting. As another example, assume a user requests assistance with financial analysis. In such a case, a data analysis AI agent may provide a spreadsheet pre-filled with data, formulas, and suggestions for pivot tables or charts based on the requested task.

In other cases, an AI agent may generate content based on the context input data (e.g., recent activities or document usage) and/or content input data. For example, assume a user has recently worked on a marketing presentation in a presentation application. In such a case, a presentation AI agent may provide relevant templates, design suggestions, or additional slides. As another example, assume a user frequently writes academic papers. In such a case, a document AI agent may suggest formatting styles or offer to autofill citations based on content in the document. As yet another example, assume a user has recently worked on budgeting. In such a case, a data analysis AI agent may suggest additional functions or provide templates for tracking expenses. A s yet another example, assume a user selects a portion of content within a document or canvas. In such a case, an AI agent may generate content based on the content input data (e.g., actual text or image) associated with the selected portion and context input data (e.g., headers or labels) associated with the selected portion.

In yet other cases, an AI agent may generate content with minimal context input data (e.g., an application is initiated but minimal to no user interactions have been captured) and/or content input data. In such a case, an AI agent may generate responses designed to guide a user through an initial experience with the application. For instance, templates or formatting tips may be suggested.

In embodiments, an AI agent may generate a proactive data or action. Proactive data, such as a teaser, may utilize a feature and present a teaser to provide an example of AI agent capabilities. In this way, the proactive teaser may provide exposure of a tool to a user. As one example, a summary snippet may be generated and presented to expose a summary of content to the user. Accordingly, a prompt may include content to summarize and context associated therewith. As another example, a list of various AI features may be presented as quick links for a user to select (e.g., based on one or more types of input data).

In some embodiments, an AI agent 216 may determine placement data. Placement data generally refers to data indicating a location in which a UI should be positioned and/or a size of the UI. In some cases, placement may be indicated as a fixed position (e.g., a pixel location at bottom-right corner). In other cases, placement may be indicated as a relative position (e.g., placed in relation to other elements, such as next to a toolbar). An AI agent 216 may determine placement for an AI assistant UI based on input data, such as user input data, context input data, content input data, an indication of an interface mode, and/or the like. As one example, placement for an AI assistant UI may be based on a portion of user selected content.

In cases in which a size is determined, fixed dimensions such as predefined height and width may be determined. In other cases, the size of the UI may be relative, for example, based on the screen size, AI assistant UI content, or the content or elements positioned on a canvas. In embodiments, the size of an AI assistant UI may be determined based on the input data, such as user input data, context input data, and/or content input data. As one example, in accordance with initially accessing a canvas, an AI assistant UI may be determined to be a predetermined size. As another example, in cases in which a document or visual design includes an extensive amount of content or elements, a size selected for an AI assistant UI may be another predetermined size.

Alternatively or additionally, the placement of an AI assistant UI may be determined by the UI manager 222. For example, placement data may be determined based on the input data, such as user input data, context input data, content input data, UI data (e.g., content data) generated by an AI agent, an interface mode, and/or the like. As one example, in accordance with initially accessing a canvas, an AI assistant UI may be determined to be positioned as a floating AI assistant UI that appears in the bottom-right corner for easy access. As another example, in cases in which text is being entered into a document (e.g., a user is typing text), an AI assistant UI may be determined to be presented inline within the document while typing.

The UI manager 226 may provide UI data 240 to a user device for presentation of an AI assistant UI. In this regard, the UI manager 226 may provide UI data 240 to the user device from which input data 230 is obtained at the AI assistant manager 212. In this way, UI manager 226 provides data to be presented that is relevant to input data, such as user input data, context input data, and/or content input data. The UI manager 226 may provide UI data in real-time such that the presented AI assistant UI is contextually relevant to the activities of the user.

The AI assistant UI may be presented in any number of ways, formats, and locations, as described herein. In some cases, the AI assistant UI may be presented in a panel, window, or user interface portion. Further, the AI assistant UI, or portion thereof, may be accessible or viewable immediately, based on a selection to view such data, etc. For instance, in some cases, an AI assistant UI may be automatically presented in line or in a distinct portion. In other cases, a link or other indicator to view an AI assistant UI may be presented. In accordance with a user selecting an AI assistant indicator (e.g., an icon or link), the user may be presented with the AI assistant UI. In yet other cases, various data may be expanded or accessed to view. For instance, an indication of an AI assistant UI may be presented. Based on a user selection of the indication of the AI assistant UI, the corresponding UI data may be expanded or presented.

The UI modifier 228 is generally configured to facilitate modification of an AI assistance UI. A s described, the UI data 240 may be used to present an AI assistance UI via a user device, such as user device 110 of FIG. 1. As can be appreciated, the AI assistance UI is presented in a manner intended to be adaptive to input data, such as user input data, context input data, and/or content input data. In some cases, however, a user may desire to modify the AI assistance UI. For example, a user may desire to move or modify the placement of the AI assistance UI. As another example, a user may desire to modify the size of the AI assistance UI. As yet another example, a user may desire to modify the interface mode associated with an AI assistance UI.

A s yet another example, a user may desire to dock or undock the AI assistance UI. For example, assume the AI assistance UI is initially presented or docked in a panel in connection with a primary window. When the AI assistant UI is docked, it is fixed or attached to a specific area, such as the right side of a main application window. The AI assistant UI may function as an integrated part of the UI and adjust its position when the main window is resized. Docking allows the interface to remain readily accessible without cluttering the screen. On the other hand, when the AI assistant UI is undocketed, it is independent from its attached position and generally becomes a floating window that can be moved independently across the screen. In this regard, a user may reposition the AI assistant UI for a customized layout. As such, depending on preferences of the user, the user may desire to dock the AI assistant UI or undock the AI Assistant UI.

The UI modifier 228 may recognize or detect such user selections and facilitate modification of the AI assistant UI in accordance with the user manipulations. In some cases, such modifications may result in analyzing the UI data and/or using an AI agent to perform such analysis. For example, assume an AI assistant UI presents 10 design options. Further assume a user reduces the size of the AI assistant UI. In such a case, the UI modifier 228, an AI agent 216, or other component, may analyze the design options in association with the modified size of the AI assistant UI and identify a manner in which to modify the design options (e.g., modify to only present five of the ten design options and add a link or scroll bar to view the additional five design options).

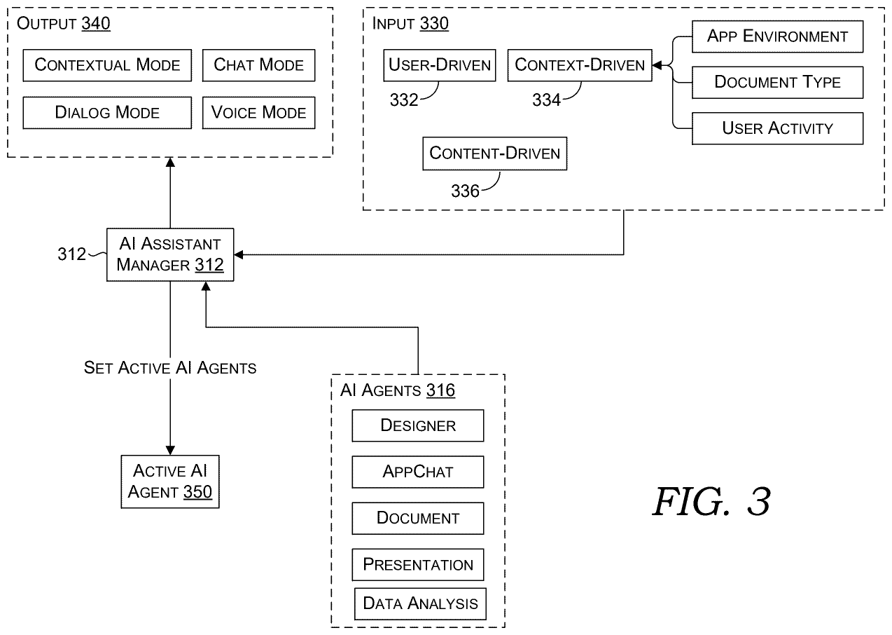

FIG. 3 provides an example implementation for facilitating presentation of an adaptive AI assistant UI, in accordance with embodiments described herein. As illustrated in FIG. 3, input data 330 is provided to the AI assistant manager 312. The input data 330 may include user-driven data 332, context-driven data 334, and content-driven data 336. As one example, user-driven data 332 may include user input queries. Context-driven data 334 may include an application environment or identifier, a document mode, and/or user activity. Content-driver data 336 may include content associated with a document or a selected portion of a document. In some cases, the input data 330 may be provided by a user device to the AI assistant manager 312.

In accordance with obtaining the input data 330, the AI assistant manager 312 may determine an interface mode to use for presenting an AI assistant UI via a user device. In particular, the AI assistant manager 312 may use rule-based intent detection to identify an interface mode for an AI assistant UI. In some examples, interface modes may include a contextual mode, a dialog mode, a chat mode, and a voice mode. In addition, the AI assistant manager 312 may identify an AI agent, from a set of AI agents 316, for use in presenting an AI assistant UI. In some cases, the AI assistant manager 312 may use rule-based intent detection to identify an AI agent. For example, based on the application environment indicated on the input data, a particular AI agent of the set of AI agents 316 may be selected. In some cases, the identified AI agent may be set or established as the active AI agent or LLM 350 for use in facilitating presentation of the AI assistant UI.

The AI assistant manager 312 may generate a prompt and provide the prompt to the identified AI agent, or active AI agent. Such a prompt may include any amount or type of input data 330, an indication of an identified interface mode, etc. In response, the AI agent may return UI data to the AI assistant manager 312. Such UI data may provide an indication of content, placement, and/or the like in association with an AI assistant UI to present to a user. The AI assistant manager 312 may provide such UI data as output 340 to the user device. A s such, the AI assistant UI may present the AI assistant UI in the interface mode identified via the AI assistant manager 312 and with content identified via a selected AI agent 350. For example, in instances in which a chat mode interface is identified, the AI assistant manager 312 provides UI data for presentation in a chat mode.

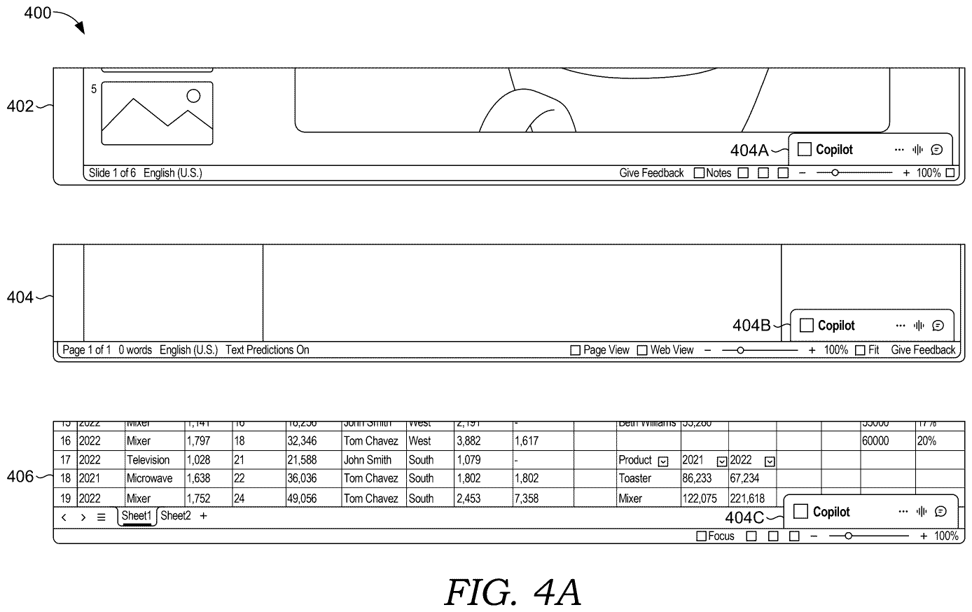

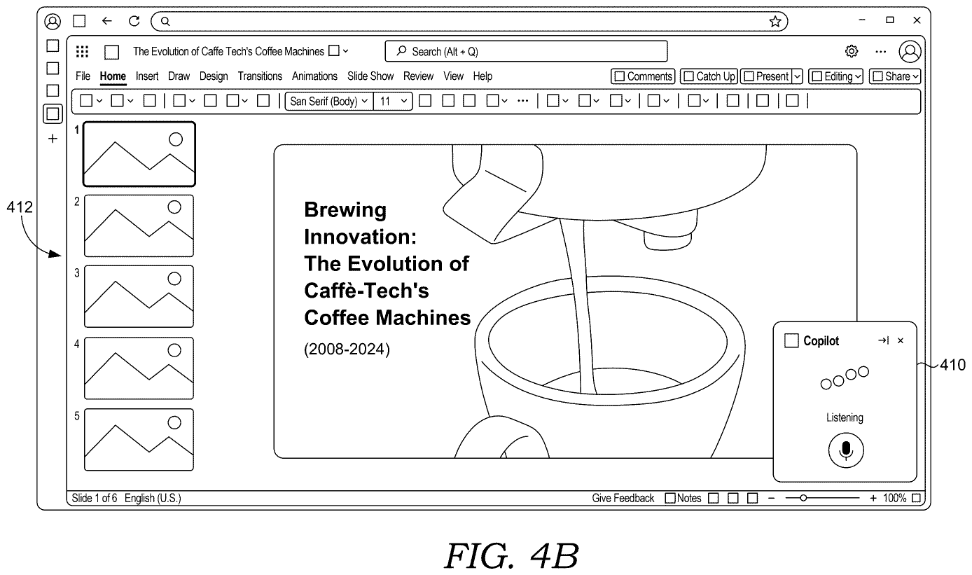

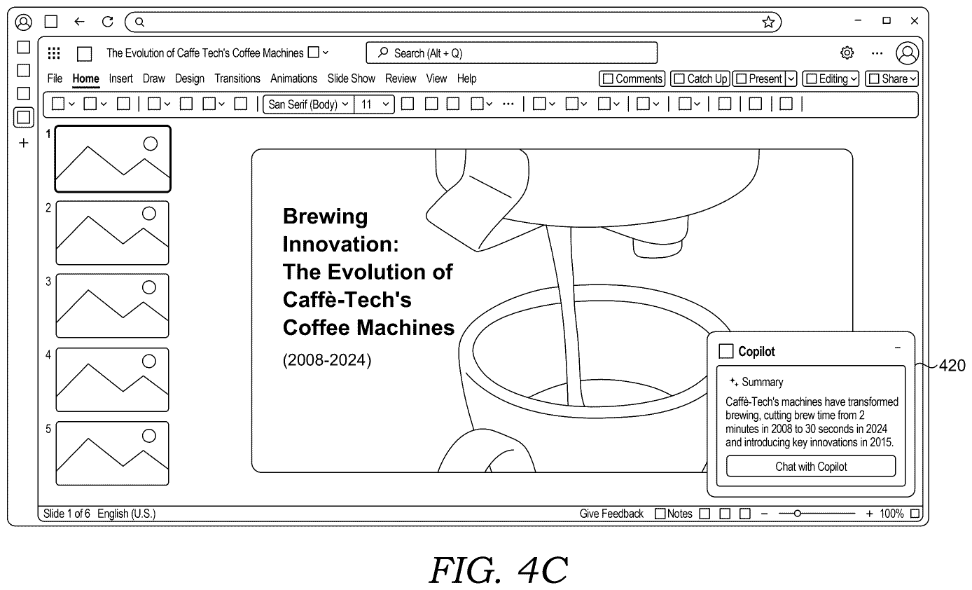

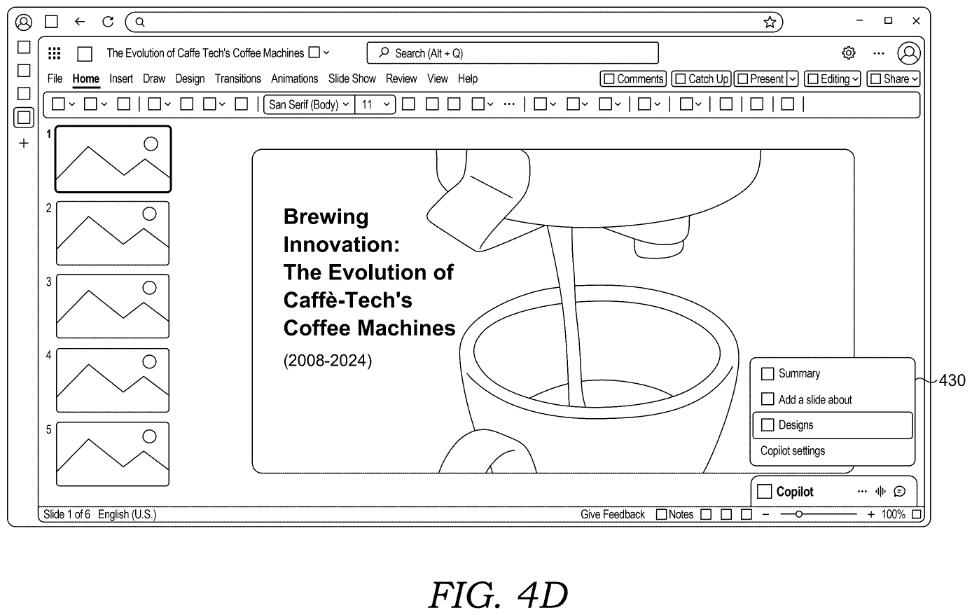

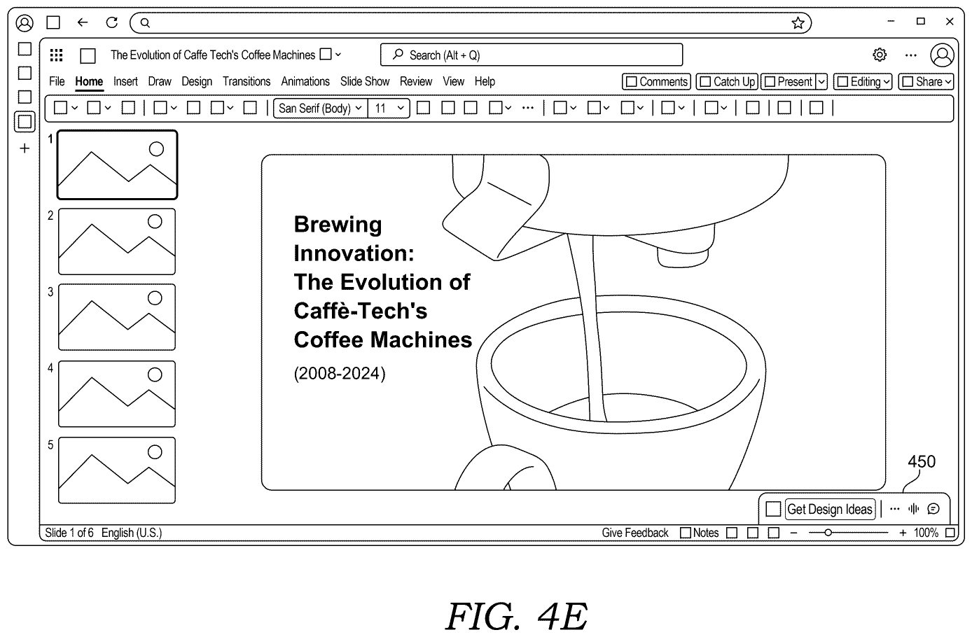

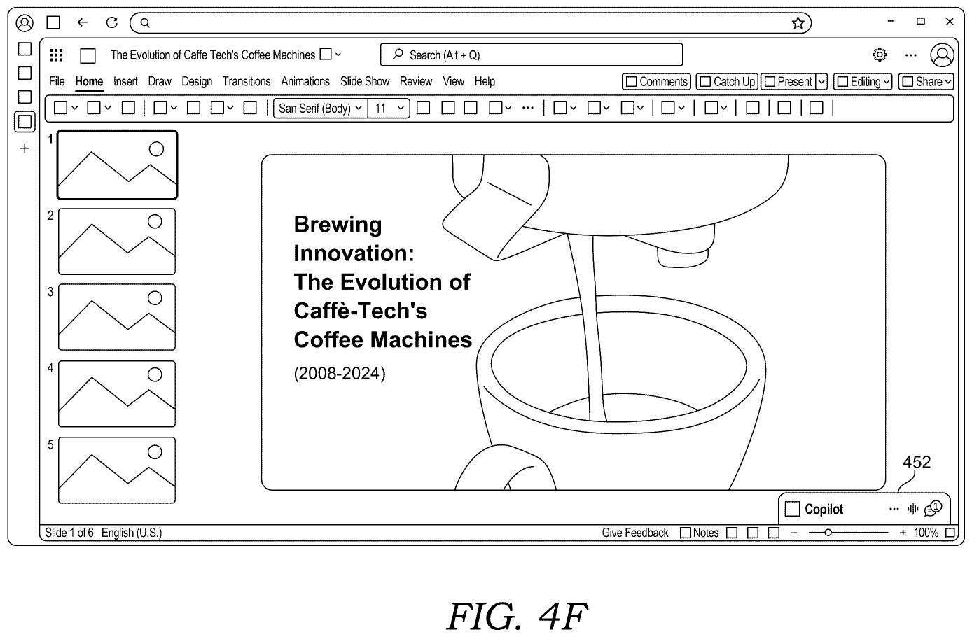

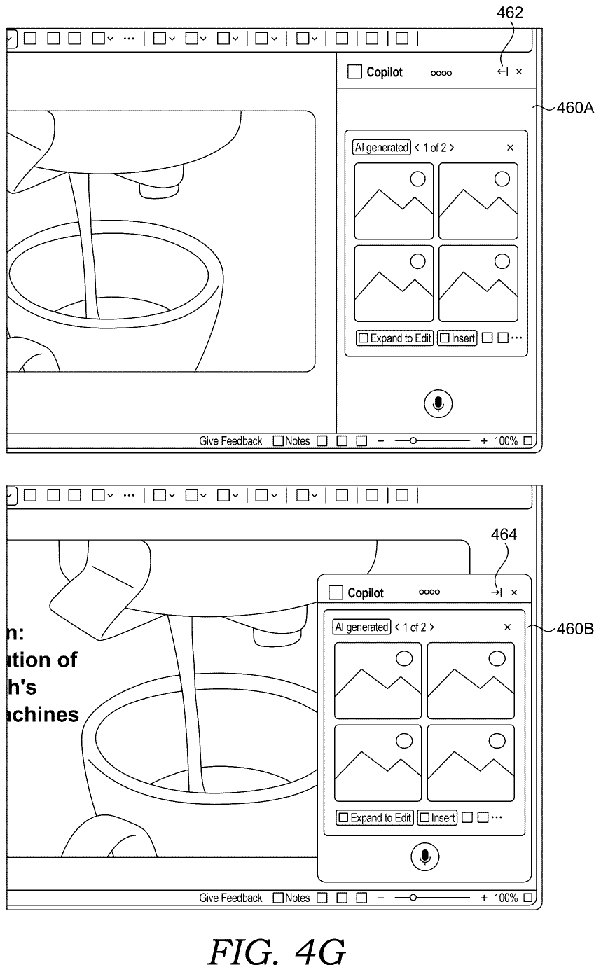

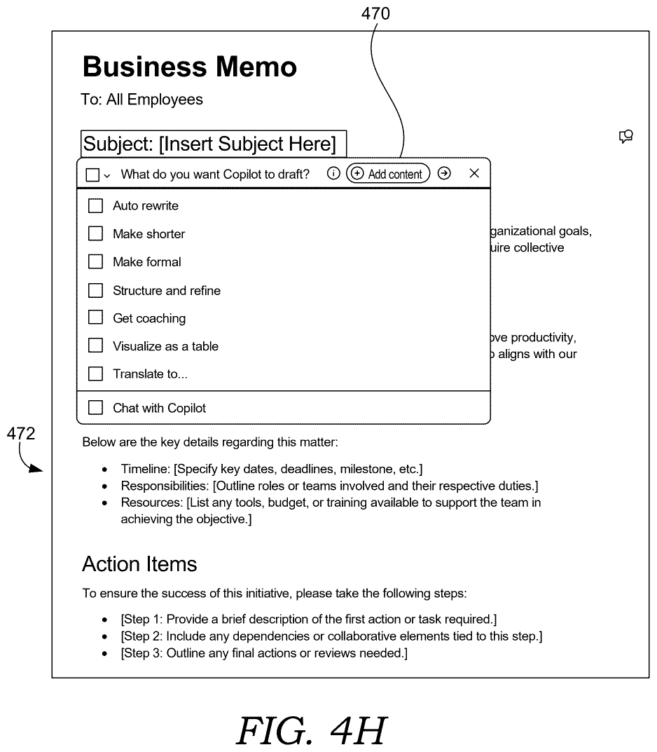

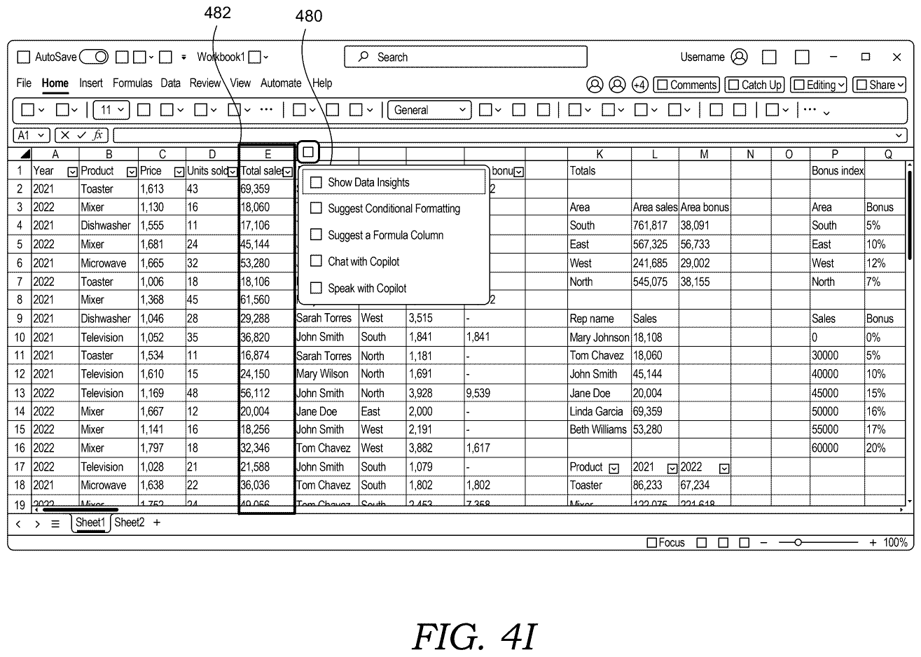

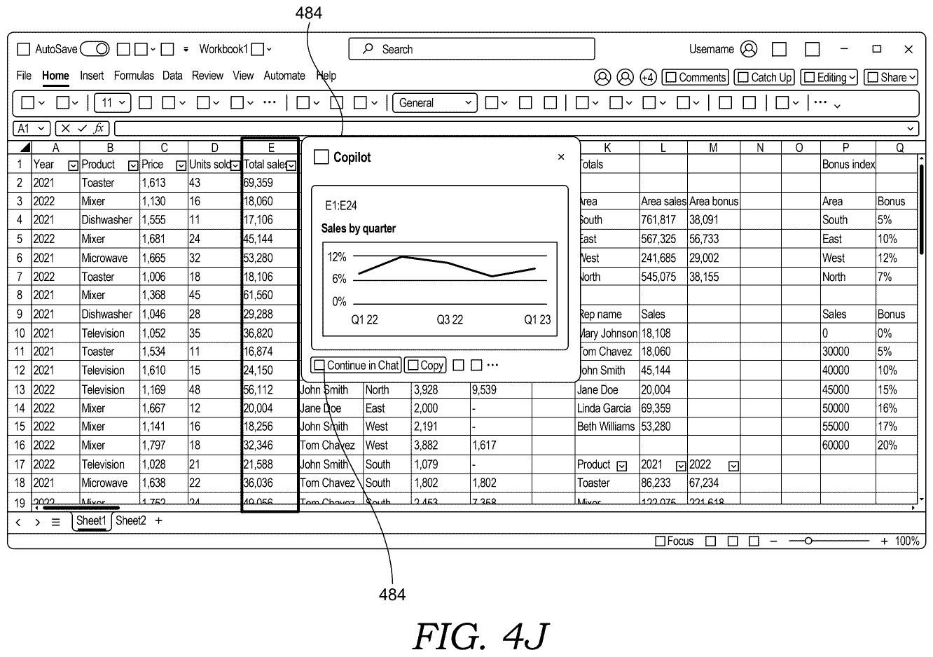

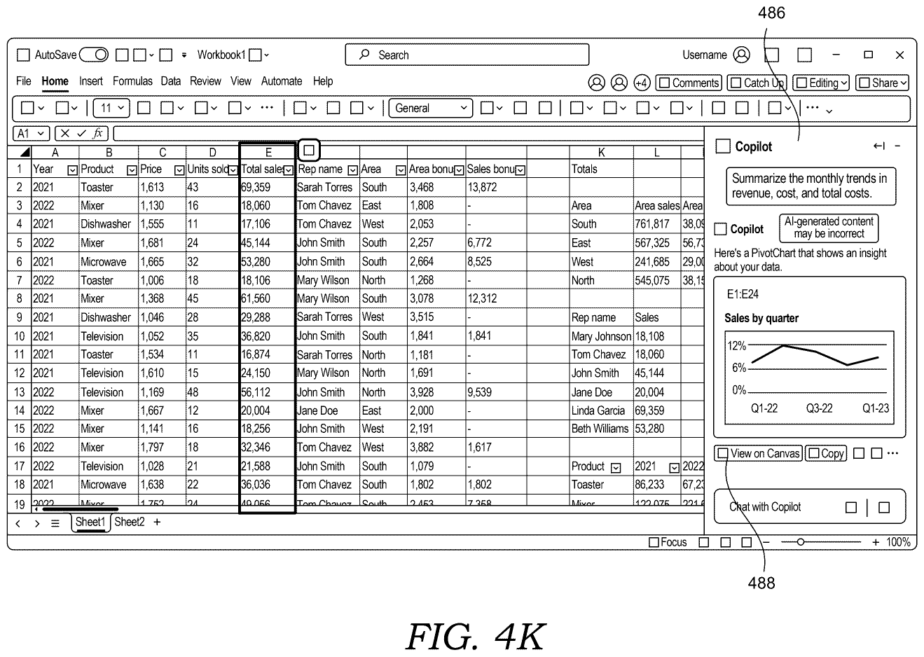

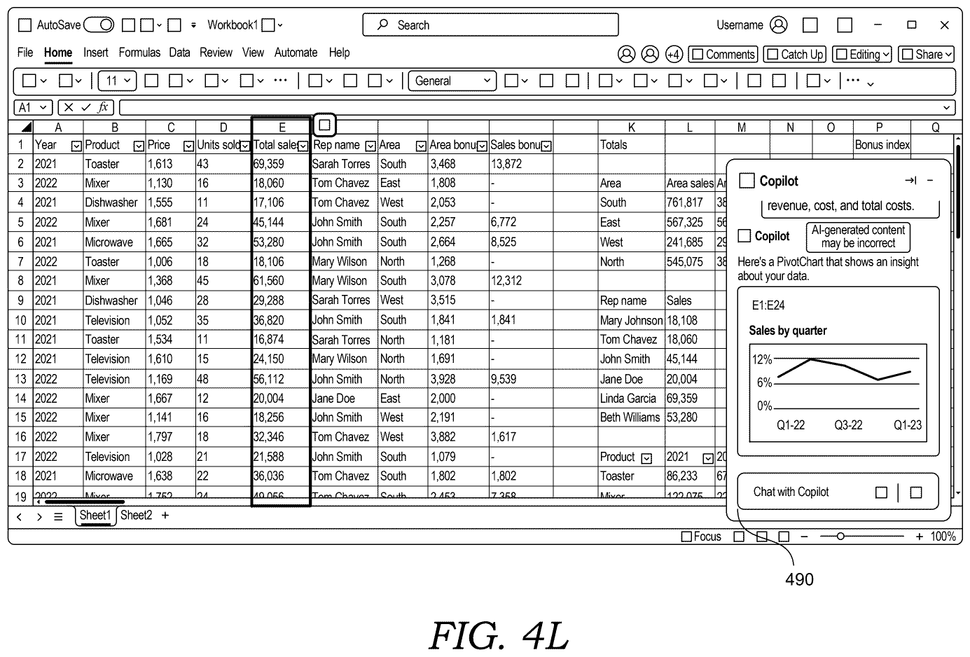

FIGS. 4A-4L provide example user interfaces in which various examples of AI assistant UIs are presented. FIG. 4A provides portions of various applications being presented. For example, document 402 provides a portion of a presentation application, document 404 provides a portion of a document application, and document 406 provides a portion of a data analysis application. In each of these examples, an AI assistant UI 404 is presented in the lower right-hand corner to provide a prominent and accessible tool. For example, document 402 includes AI assistant UI 404A, document 404 includes AI assistant UI 404B, and document 406 includes AI assistant UI 404C. Such an AI assistant UI provides a readily available visualization of the AI functionality for efficient access by a user. Display in a consistent manner across applications enables predictability and ease of use for a user. However, such an AI assistant UI need not be displayed consistently across applications. In this example, AI assistant UI 404 may be presented in initially accessing a document, such as document 402, 404, and/or 406. In other cases, AI assistant UI 404 may be presented in such a manner based on a lack of other contextual data to adapt the AI assistant UI. A user selection of AI assistant UI 404 facilitates further user interaction with a corresponding AI agent to enable efficient and effective use of AI to obtain relevant information.

Turning to FIG. 4B, FIG. 4B provides an AI assistant UI 410 provided in a voice interface mode. A voice interface mode may be identified or selected based on any number or type of data. For example, a voice interface mode may be selected based on the amount or type of content presented via the application 412, prior user activity or interaction with the application 412, etc. As another example, a voice interface mode may be selected to promote the voice feature of AI assistants. Further, the placement of the AI assistant UI 410 may be based on, for example, the content, and position thereof, presented via the application 412.

With reference to FIG. 4C, FIG. 4C provides an AI assistant UI 420 that promotes an AI feature. In this way, a summarization feature is presented to enable better discoverability by a user. In this example, the AI assistant UI 420 provides a snippet or portion of a summary along with a link to chat with an AI agent. In this way, the visibility and discoverability of the summarization feature of an AI agent is enhanced. Such an AI assistant UI 420 may be generated in response to a prompt that includes, for example, user input data, context input data, and/or content input data.

In FIG. 4D, FIG. 4D provides an AI assistant UI 430 that promotes various AI features. As such, the AI assistant UI 430 provides discoverability of various AI features that a user may utilize. In this example AI assistant UI 430, various proactive actions or features are presented, including a summary action, an add a slide action, and a design action. In this way, a user may readily see available options for using AI to facilitate understanding or generation of presentation content. In cases in which a user selects the summary action, the AI assistant UI may be adapted to provide a response that summarizes the content (e.g., of the page or the presentation). In cases in which a user selects the add a slide action, the AI assistant UI may be adapted to provide a response corresponding with adding a slide to the presentation. In cases in which a user selects the designs action, the AI assistant UI may be adapted to provide a set of designs for the user to view. The particular AI features promoted may be selected based on various types of data, such as content input data and/or context input data.

FIG. 4E provides an AI assistant UI 450 that includes a proactive suggestion to “Get Design Ideas.” FIG. 4F provides an AI assistant UI 452 that includes a proactive notification. As show, the AI assistant UI 452 includes an indication or alert that there is one notification. Such a notification may include any type of details, such as suggestions, information, etc.

Turning to FIG. 4G, FIG. 4G provides an AI assistant UI 460. In this example, the AI assistant UI 460A may initially be presented in a panel adjacent to the content of the application. In such a case the AI assistant UI 460A is a docked or static position. In association with selecting an undocking indicator 462, the AI assistant UI may be transformed to an undocked AI assistant UI 460B. In this regard, the AI assistant UI 460B may be moved (e.g., by a user) around the display in a manner that is most suitable for the user. To dock the AI assistant UI, the user may select the docking indicator 464. In this example, the design interface mode is selected to present various designs. The number of designs presented may be determined based on the size of the AI assistant UI or other data. The number, type, and/or content of the designs presented in the AI assistant UI may be based on the content or context associated with the document, or portion thereof (e.g., a selected slide or selected portion of content), among other things.

In FIG. 4H, AI assistant UI 470 is provided in a contextual interface mode format. In this example, the AI assistant UI 470 provides an option to input a query and provides a set of tasks that may be performed in association with the content of the document 472. In this example, the AI assistant UI 470 is in placed in line with the document. In embodiments, the set of tasks may be selected for the AI assistant UI 470 based on various data, such as user input data, context input data, and/or content input data.

With reference to FIG. 4I, FIG. 4I provides an AI assistant UI 480 that provides various AI analysis options, such as share data insights, suggest conditional formatting, suggest a formula column, chat with copilot, and speak with copilot. Such actions may be presented in proximity to selected data 482. In some cases, the actions presented within the AI assistant UI 480 may be determined or selected using various data, such as user input data, context input data, and/or content input data. For example, as shown, the selected data 482 is a column of numbers in a table. In such a case, relevant context may include an indication that the selected data is a table column in a spreadsheet workbook with headers. Relevant content may include the numbers and the header of “Total sales.” Based on such context and content and available action options for the corresponding application, the actions of Show Data Insights, Suggest Conditional Formatting, Suggest a Formula Column, etc. may be selected for the AI assistant UI 480. A s can be appreciated, different content in the column (e.g., hyperlinks) may result in different actions selected for and presented in association with the AI assistant UI 480.

Assume a user selects the option to share data insights. In such a case, the user may be presented with data insights, as shown in FIG. 4J. FIG. 4I provides an AI assistant UI 484 that is positioned in proximity to the selected data. In this example, the AI assistant UI 484 presents data insights, for example, using a data analysis AI agent. Such data insights may be generated based on various data, such as content input data and/or context input data. The placement and content of the AI assistant UI enables the user to remain focused on a task being performed. In some cases, the AI assistant UI 484 may be automatically presented upon a user selecting data. In other cases, the user may select an option to view a relevant AI assistant UI, for example, as in FIG. 4I. As shown, the user may select the continue in chat indicator 484 to morph or transition to an AI assistant UI in the form of an app chat. In this regard, FIG. 4K illustrates an example AI assistant UI 486 in the form of a docked chat pane. A s discussed, the user may desire to view the chat pane in a more integrated manner. In such a case, assume the user selects to view on canvas 488. Based on the selection, the AI assistant in the form of a chat pane may be undocked, as shown via AI assistant UI 490 in FIG. 4L.

As discussed, various implementations and combinations of technologies may be used to implement various aspects related to providing AI assistant UIs in an adaptive manner. In some cases, the particular technologies employed may depend on the application utilizing such technologies.

### Exemplary Implementations for Facilitating Adaptive AI Assistant UIs

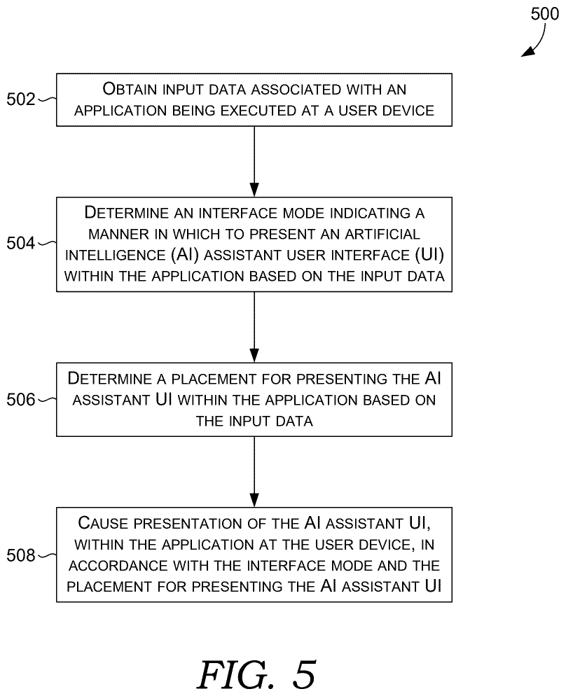

As described, various implementations can be used in accordance with embodiments described herein. FIGS. 5-7 provide methods of facilitating adaptive AI assistant UIs, in accordance with embodiments described herein. The methods 500, 600, and 700 can be performed by a computer device, such as device 800 described below. The flow diagrams represented in FIGS. 5-7 are intended to be exemplary in nature and not limiting. For example, flow diagrams represented in FIGS. 5-7 represent various combinations of technologies and approaches used to manage facilitating adaptive AI assistant UIs, but are not intended to reflect all combinations of technologies and approaches that may be used in accordance with embodiments described herein.

With respect to FIG. 5, FIG. 5 provides an example method flow 500 for providing adaptive AI assistant UIs, in accordance with embodiments described herein. At block 502, input data associated with an application being executed at a user device is obtained. Input data may include user input data and/or context input data, such as an indication of a type of application, a document mode, user activity, etc.

At block 504, an interface mode indicating a manner in which to present an AI assistant UI within the application is determined based on the input data. A n interface mode may be identified from a set of predetermined interface modes, such as a contextual mode, a dialog mode, a chat mode, and a voice mode. As one example, an interface mode for presenting the AI assistant UI in a particular mode may be based on the application being used, a document mode, user activity, a user query, and/or the like.

At block 506, a placement for presenting the AI assistant UI within the application is determined based on the input data. In some cases, a placement for presenting the AI assistant UI is determined via an AI agent. A n AI agent may be identified, from among a set of AI agents, for use in facilitating presentation of the AI assistant UI. Examples of AI agents include a designer AI agent, an app chat AI agent, a document AI agent, a presentation AI agent, a data analysis AI agent, or the like. Upon identifying the AI agent, the AI agent may be provided with a prompt (e.g., including the interface mode) and provide a response including an indication of a placement for presenting the AI assistant UI. In other cases, a placement for presenting the AI assistant UI may be determined via a set of rules.

At block 508, the AI assistant UI is presented within the application at the user device in accordance with the interface mode and the placement for presenting the AI assistant UI. The AI assistant UI may present various types of content. A s one example, the AI assistant UI may include context-aware AI task suggestions (e.g., generate a summary, generate a data insight, etc.) based on the input data. In accordance with presenting an AI assistant UI, a user may interact with the AI assistant UI, for example, to obtain information (e.g., in response to an input query) or to modify the AI assistant UI (e.g., to modify the position or size of the AI assistant UI). In addition to modifying the AI assistant UI in accordance with user preferences, the AI assistant UI may be automatically updated or modified based on updated or new input data. For example, as the user progresses in providing content in slides of a presentation, the AI assistant UI may be modified in size, location, content, task suggestions, etc. to account for the dynamically adjusted context associated with the application.

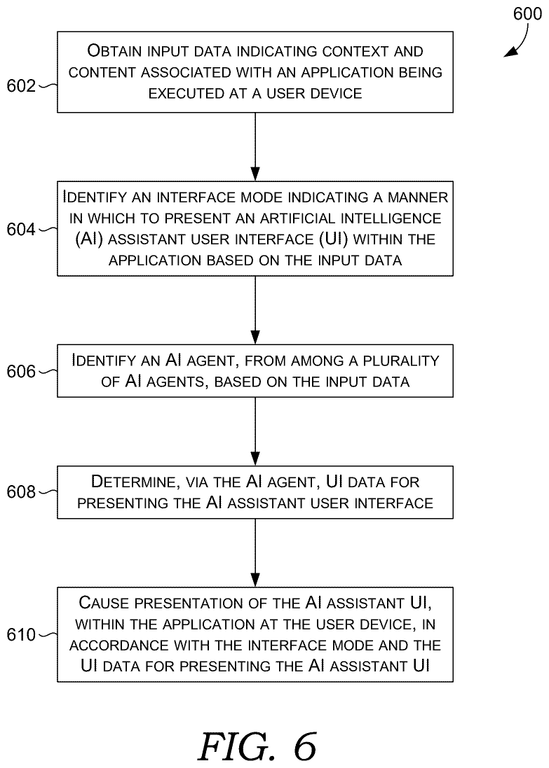

Turning to FIG. 6, FIG. 6 provides another example method flow 600 for providing adaptive AI assistant UIs, in accordance with embodiments described herein. Initially, at block 602, input data associated with an application being executed at a user device is obtained.

At block 604, an interface mode indicating a manner in which to present an AI assistant UI within the application is identified based on the input data. For example, user input data and/or context input data may be used to determine which interface mode, among a set of interface modes, is intended or desired for use. In some cases, a rules-based approach may be used to identify a particular interface mode for presenting an AI assistant UI.

At block 606, an AI agent is identified, from among a plurality of AI agents, based on the input data. For example, user input data and/or context input data may be used to determine which AI agent, among a set of AI agents, is intended or desired for use. In some cases, a rules-based approach may be used to identify a particular AI agent for use in presenting an AI assistant UI.

At block 608, UI data for presenting the AI assistant UI is determined via the AI agent. In embodiments, UI data for presenting the AI assistant UI is determined based on the interface mode. In this way, a prompt, including the interface mode, may be provided to the AI agent for determining or generating UI data for presenting the AI assistant UI. In some cases, the UI data includes a location at which to place the AI assistant UI, a size for the AI assistant UI, content for the AI assistant UI, an indication of an AI task that may be performed by the AI agent, etc.

At block 610, the AI assistant UI is presented within the application at the user device in accordance with the interface mode and the UI data for presenting the AI assistant UI. As such, the AI assistant UI may be presented using the identified interface mode (e.g., voice mode) and in a targeted location.

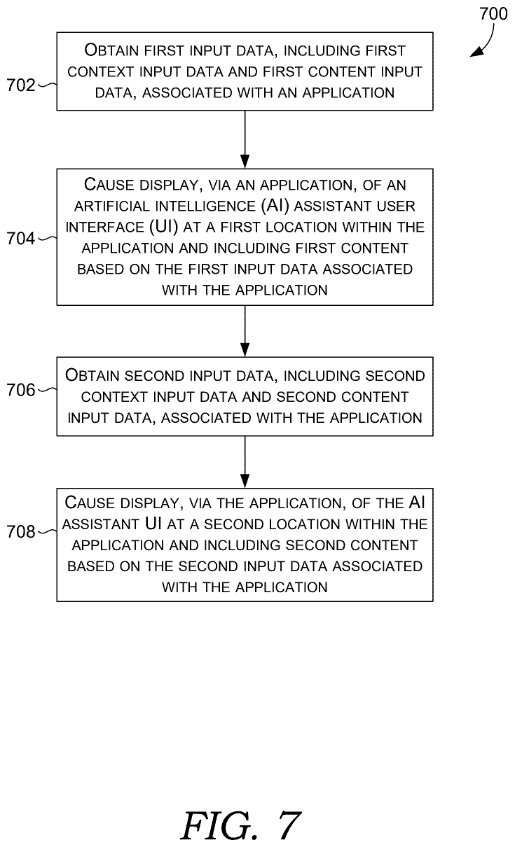

Turning to FIG. 7, FIG. 7 provides an example method flow 700 for providing adaptive AI assistant UIs, in accordance with embodiments described herein. Initially, at block 702, first input data associated with an application is obtained. The first input data may include user input data and/or context input data, such as an indication of user activity in association with the application, a document mode, and/or an application identifier.

At block 704, an AI assistant UI is displayed, via an application, at a first location within the application and includes first content based on the first input data associated with the application. Such content may include any type of information, such as a response to a query (e.g., a text response, a design or image response). As another example, the content may include an indication of an AI task that may be performed by an AI agent.

At block 706, second input data associated with the application is obtained. The second input data may include user input data and/or context input data, such as an indication of user activity in association with the application, a document mode, and/or an application identifier.

At block 708, the AI assistant UI is displayed at a second location within the application and includes second content based on the second input data associated with the application. In embodiments, the first location and the second location are different based on the first input data being different from the second input data. In some cases, the second content may be determined in accordance with an interface mode identified for the AI assistant UI based on the first input data or the second input data. Such content may include any type of information, such as a response to a query (e.g., a text response, a design or image response). As another example, the content may include an indication of an AI task that may be performed by an AI agent.

Accordingly, various aspects of technology are directed to systems, methods, and graphical user interfaces for intelligently generating and providing adaptive AI assistant UIs in a contextually relevant manner. It is understood that various features, subcombinations, and modifications of the embodiments described herein are of utility and may be employed in other embodiments without reference to other features or subcombinations. Moreover, the order and sequences of steps shown in the example methods 500, 600, and 700 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include obtaining input data associated with an application being executed at a user device. The operations further include determining an interface mode indicating a manner in which to present an artificial intelligence (AI) assistant user interface (UI) within the application based on the input data. The operations further include determining a placement for presenting the AI assistant UI within the application based on the input data. The operations further include causing presentation of the AI assistant UI, within the application at the user device, in accordance with the interface mode and the placement for presenting the AI assistant UI. Advantageously, the AI assistant UI is presented in an adaptive manner, thereby enabling a more efficient user experience and, as such, resulting reduced usage of computer resources.

In any combination of the above embodiments of the computing system, the input data comprises context input data indicating a type of application, a document mode, user activity, or a combination thereof.

In any combination of the above embodiments of the computing system, the interface mode comprises a contextual mode, a dialog mode, a chat mode, or a voice mode.

In any combination of the above embodiments of the computing system, identifying an AI agent, from among a plurality of AI agents, to use to facilitate presentation of the AI assistant UI.

In any combination of the above embodiments of the computing system, the AI agent is used to determine the placement for presenting the AI assistant UI within the application.

In any combination of the above embodiments of the computing system, the AI agent comprises a designer AI agent, an app chat AI agent, a document AI agent, a presentation AI agent, or a data analysis AI agent.

In any combination of the above embodiments of the computing system, obtaining a user interaction with the AI assistant UI; and modifying the AI assistant UI based on the user interaction with the AI assistant UI.

In any combination of the above embodiments of the computing system, the AI assistant UI includes context-aware AI task suggestions based on the input data.

In any combination of the above embodiments of the computing system, automatically updating the placement for presenting the AI assistant UI based on a set of new input data.

In other embodiments, a computer-implemented method is provided. The method includes obtaining input data associated with an application being executed at a user device. The method further includes identifying an interface mode indicating a manner in which to present an artificial intelligence (AI) assistant user interface (UI) within the application based on the input data. The method further includes identifying an AI agent, from among a plurality of AI agents, based on the input data. The method further includes determining, via the AI agent, UI data for presenting the AI assistant UI. The method also includes causing presentation of the AI assistant UI, within the application at the user device, in accordance with the interface mode and the UI data for presenting the AI assistant UI. Advantageously, the AI assistant UI is presented in an adaptive manner, thereby enabling a more efficient user experience and, as such, resulting reduced usage of computer resources.

In any combination of the above embodiments of the computer-implemented method, the UI data is determined based on the interface model.

In any combination of the above embodiments of the computer-implemented method, the UI data includes a location at which to place the AI assistant UI.

In any combination of the above embodiments of the computer-implemented method, the UI data includes content to include in the AI assistant UI.

In any combination of the above embodiments of the computer-implemented method, the UI data includes an indication of at least one AI task that may be performed by the AI agent.

In any combination of the above embodiments of the computer-implemented method, determining UI data via the AI agent comprises generating a prompt that includes the interface mode and providing the prompt to the AI agent.

In other embodiments, one or more computer storage media having computer-executable instructions embodied thereon that, when executed by one or more processors, cause the one or more processors to perform a method is provided. The method includes obtaining first input data associated with an application. The method further includes causing display, via an application, of an artificial intelligence (AI) assistant user interface (UI) at a first location within the application and including first content based on the first input data associated with the application. The method further includes obtaining second input data associated with the application. The method further includes causing display, via the application, of the AI assistant UI at a second location within the application and including second content based on the second input data associated with the application. Advantageously, the AI assistant UI is presented in an adaptive manner, thereby enabling a more efficient user experience and, as such, resulting reduced usage of computer resources.

In any combination of the above embodiments of the media, the first input data and the second input data comprises context input data indicating user activity in association with the application, a document mode, and/or an application identifier.

In any combination of the above embodiments of the media, the first location and the second location are different based on the first input data being different from the second input data.

In any combination of the above embodiments of the media, determining the second content in accordance with an interface mode identified for the AI assistant UI based on the first input data.

In any combination of the above embodiments of the media, the first content comprises an indication of a first AI task that may be performed by an AI agent and the second content comprises an indication of a second AI task that may be performed by the AI agent.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 8 in particular, an exemplary operating environment for implementing aspects of the technology described herein is shown and designated generally as computing device 800. Computing device 800 is just one example of a suitable computing environment and is not intended to suggest any limitation as to the scope of use or functionality of the technology described herein, and nor should the computing device 800 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 8, computing device 800 includes a bus 810 that directly or indirectly couples the following devices: memory 812, one or more processors 814, one or more presentation components 816, input/output (I/O) ports 818, I/O components 820, an illustrative power supply 822, and a radio(s) 824. Bus 810 represents what may be one or more buses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 8 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 8 and refer to “computer” or “computing device.”

Computing device 800 typically includes a variety of computer-readable media. Computer-readable media can be any available media that can be accessed by computing device 800 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 812 includes computer storage media in the form of volatile and/or non-volatile memory. The memory 812 may be removable, non-removable, or a combination thereof. Exemplary memory includes solid-state memory, hard drives, and optical-disc drives. Computing device 800 includes one or more processors 814 that read data from various entities such as bus 810, memory 812, or I/O components 820. Presentation component(s) 816 present data indications to a user or other device. Exemplary presentation components 816 include a display device, speaker, printing component, and vibrating component. I/O port(s) 818 allow computing device 800 to be logically coupled to other devices including I/O components 820, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 814 may be director via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 800. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 800. The computing device 800 may be equipped with depth cameras, such as stereoscopic camera systems, infrared camera systems, RGB camera systems, and combinations of these, for gesture detection and recognition. Additionally, the computing device 800 may be equipped with accelerometers or gyroscopes that enable detection of motion. The output of the accelerometers or gyroscopes may be provided to the display of the computing device 800 to render immersive augmented reality or virtual reality.

A computing device may include radio(s) 824. The radio 824 transmits and receives radio communications. The computing device may be a wireless terminal adapted to receive communications and media over various wireless networks. Computing device 700 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 9, FIG. 9 isa block diagram of a language model 900 (for example, a BERT model or Generative Pre-trained Transformer [GPT]-4 model) that uses particular inputs to make particular predictions (for example, answers to questions), according to some embodiments. In one embodiment, the language model 900 corresponds to the AI agents 215 of FIG. 2 described herein. In various embodiments, the language model 900 includes one or more encoders and/or decoder blocks 906 (or any transformer or portion thereof).

First, a natural language corpus (for example, various WIKIPEDIA English words or BooksCorpus) of the inputs 901 are converted into tokens and then feature vectors and embedded into an input embedding 902 to derive meaning of individual natural language words (for example, English semantics) during pre-training. In some embodiments, to understand English language, corpus documents, such as text books, periodicals, blogs, social media feeds, and the like are ingested by the language model 900.

In some embodiments, each word or character in the input(s) 901 is mapped into the input embedding 902 in parallel or at the same time, unlike existing long short-term memory (LSTM) models, for example. The input embedding 902 maps a word to a feature vector representing the word. But the same word (for example, “apple”) in different sentences may have different meanings (for example, brand versus fruit). This is why a positional encoder 904 can be implemented. A positional encoder 904 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

PE_{(pos,2i)}=sin(pos/10000^{2i/d}^{_{model}}) (1)

PE_{(pos,2i+1)}=cos(pos/10000^{2i/d}^{_{model}}) (2)

After passing the input(s) 901 through the input embedding 902 and applying the positional encoder 904, the output is a word embedding feature vector, which encodes positional information or context based on the positional encoder 904. These word embedding feature vectors are then passed to the encoder and/or decoder block(s) 906, where it goes through a multi-head attention layer 906-1 and a feedforward layer 906-2. The multi-head attention layer 906-1 is generally responsible for focusing or processing certain parts of the feature vectors representing specific portions of the input(s) 901 by generating attention vectors. For example, in Question-Answering systems, the multi-head attention layer 906-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k}, and W^{v}, so there are multiple attention vectors Z for every word. However, a neural network may expect one attention vector per word. Accordingly, another weighted matrix, W^{z}, is used to make sure the output is still an attention vector per word. In some embodiments, after the layers 906-1 and 906-2, there is some form of normalization (for example, batch normalization and/or layer normalization) performed to smoothen out the loss surface, making it easier to optimize while using larger learning rates.

Layers 906-3 and 906-4 represent residual connection and/or normalization layers where normalization recenters and rescales or normalizes the data across the feature dimensions. The feedforward layer 906-2 is a feedforward neural network that is applied to every one of the attention vectors outputted by the multi-head attention layer 906-1. The feedforward layer 906-2 transforms the attention vectors into a form that can be processed by the next encoder block or make a prediction at 908. For example, given that a document includes a first natural language sequence “the due date is . . . ,” the encoder/decoder block(s) 906 predicts that the next natural language sequence will be a specific date or particular words based on past documents that include language identical or similar to the first natural language sequence.

In some embodiments, the encoder/decoder block(s) 906 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 906 learns what language and context for a word is in pre-training by training on two unsupervised tasks (M asked Language Model [MLM] and Next Sentence Prediction [NSP]) simultaneously or at the same time. In terms of the inputs and outputs, at pre-training, the natural language corpus of the inputs 801 may be various historical documents, such as text books, journals, and periodicals, in order to output the predicted natural language characters in 808 (not make the predictions at runtime or prompt engineering at this point). The example encoder/decoder block(s) 906 takes in a sentence, paragraph, or sequence (for example, included in the input[s] 901), with random words being replaced with masks. The goal is to output the value or meaning of the masked tokens. For example, if a line reads, “please [MASK] this document promptly,” the prediction for the “mask” value is “send.” This helps the encoder/decoder block(s) 906 understand the bidirectional context in a sentence, paragraph, or line at a document. In the case of NSP, the encoder/decoder block(s) 906 takes, as input, two or more elements, such as sentences, lines, or paragraphs, and determines, for example, if a second sentence in a document actually follows (for example, is directly below) a first sentence in the document. This helps the encoder/decoder block(s) 906 understand the context across all the elements of a document, not just within a single element. Using both of these together, the encoder/decoder block(s) 906 derives a good understanding of natural language.

In some embodiments, during pre-training, the input to the encoder/decoder block(s) 906 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 902). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 902) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 901) that are encoded into a vector (for example, first sentence, second sentence, and so forth, assuming a top-down and right-to-left approach). The position embeddings are vectors that represent the position of a particular word in such a sentence that can be produced by positional encoder 904. When these three embeddings are added or concatenated together, an embedding vector is generated that is used as input into the encoder/decoder block(s) 906. The segment and position embeddings are used for temporal ordering since all of the vectors are fed into the encoder/decoder block(s) 906 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 906 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 906 processing the inputs 903A and/or 903B in order to make the predictions and generate a prompt response, as indicated in 904. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem”]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
obtaining input data associated with an application being executed at a user device;
determining an interface mode indicating a manner in which to present an artificial intelligence (AI) assistant user interface (UI) within the application based on the input data;
determining a placement for presenting the AI assistant UI within the application based on the input data; and
causing presentation of the AI assistant UI, within the application at the user device, in accordance with the interface mode and the placement for presenting the AI assistant UI.

2. The computing system of claim 1, wherein the input data comprises context input data indicating a type of application, a document mode, user activity, or a combination thereof.

3. The computing system of claim 1, wherein the input data comprises content input data indicating content within the application or user-selected content within the application.

4. The computing system of claim 1, further comprising identifying an AI agent, from among a plurality of AI agents, to use to facilitate presentation of the AI assistant UI.

5. The computing system of claim 4, wherein the AI agent is used to determine the placement for presenting the AI assistant UI within the application.

6. The computing system of claim 4, wherein the AI agent comprises a designer AI agent, an app chat AI agent, a document AI agent, a presentation AI agent, or a data analysis AI agent.

7. The computing system of claim 1 further comprising:
obtaining a user interaction with the AI assistant UI; and
modifying the AI assistant UI based on the user interaction with the AI assistant UI.

8. The computing system of claim 1, wherein the AI assistant UI includes context-aware AI task suggestions based on the input data.

9. The computing system of claim 1, further comprising automatically updating the placement for presenting the AI assistant UI based on a set of new input data.

10. A computer-implemented method comprising:
obtaining input data indicating context and content associated with an application being executed at a user device;
identifying an interface mode indicating a manner in which to present an artificial intelligence (AI) assistant user interface (UI) within the application based on the input data;
identifying an AI agent, from among a plurality of AI agents, based on the input data;
determining, via the AI agent, UI data for presenting the AI assistant UI; and
causing presentation of the AI assistant UI, within the application at the user device, in accordance with the interface mode and the UI data for presenting the AI assistant UI.

11. The computer-implemented method of claim 10, wherein the UI data is determined based on the interface mode.

12. The computer-implemented method of claim 10, wherein the UI data includes a location at which to place the AI assistant UI.

13. The computer-implemented method of claim 10, wherein the UI data includes content to include in the AI assistant UI.

14. The computer-implemented method of claim 10, wherein the UI data includes an indication of at least one AI task that may be performed by the AI agent.

15. The computer-implemented method of claim 10, wherein determining UI data via the AI agent comprises generating a prompt that includes the interface mode and at least a portion of the input data indicating the context and content associated with the application and providing the prompt to the AI agent.

16. One or more computer storage media having computer-executable instructions embodied thereon that, when executed by one or more processors, cause the one or more processors to perform a method, the method comprising:
obtaining first input data, including first context input data and first content input data, associated with an application;
causing display, via an application, of an artificial intelligence (AI) assistant user interface (UI) at a first location within the application and including first content based on the first input data associated with the application;
obtaining second input data, including second context input data and second content input data, associated with the application; and
causing display, via the application, of the AI assistant UI at a second location within the application and including second content based on the second input data associated with the application.

17. The media of claim 16, wherein the first input data and the second input data comprises a document mode and/or an application identifier, the first context input data and the second context input data comprises data indicating user activity in association with the application, and the first content input data and the second content input data comprises content associated with the user activity in association with the application.

18. The media of claim 16, wherein the first location and the second location are different based on the first input data being different from the second input data.

19. The media of claim 16 further comprising determining the second content in accordance with an interface mode identified for the AI assistant UI based on the first input data.

20. The media of claim 16, wherein the first content comprises an indication of a first AI task that may be performed by an AI agent, and the second content comprises an indication of a second AI task that may be performed by the AI agent.
